(19) United States
(12) Patent Application Publication
(10) Pub. No.: US 2015/0310956 A1
(43) Pub. Date: Oct. 29, 2015

(54) Method for Producing An Electrical Contact Element For Preventing Tin Whisker Formation, and Contact Element

(71) Applicant: TYCO ELECTRONICS AMP GMBH, Bensheim (DE)

(72) Inventor: Helge Schmidt, Speyer (DE)

(73) Assignee: TYCO ELECTRONICS AMP GMBH, Bensheim (DE)

(21) Appl. No.: 14/695,780

(22) Filed: Apr. 24, 2015

(30) Foreign Application Priority Data
Apr. 24, 2014 (DE) 102014005941.3

(51) Int. Cl. H01B 1/02; H01B 13/00; H01B 5/00

(52) U.S. Cl. CPC H01B 1/02; H01B 5/00; H01B 13/0026

(57) ABSTRACT

A method for producing an electrical contact element comprises the steps of providing a base material, and applying at least one electrically conductive contact layer to the base material. The contact layer has an outer surface which is elevated by roughness and which is suitable for receiving a lubricant.

### CROSS-REFERENCE TO RELATED APPLICATIONS

This application claims priority under 35 U.S.C. §119(a)-(d) or (f) to German Patent Application No. 102014005941.3, filed Apr. 24, 2014.

### FIELD OF THE INVENTION

The invention is generally related to a method for producing an electrical contact element, and, more specifically, a method for producing an electrical contact element that prevents the formation of tin whiskers.

### BACKGROUND

The use of tin as an electrically conductive material in electronic circuits often results in the formation of tin whiskers or filaments. The tin whiskers are needle-like formations of tin which form primarily on surfaces with lead-free, tin coatings. The whiskers may have a length of up to 1 mm and, in extreme cases, up to 2 mm. They are electrically conductive and can therefore result in short-circuits on assembled printed circuit boards. Currents of 10 to 50 mA may flow through a whisker. Generally, when current flows through a whisker, the whisker does not melt, but instead, breaks off at a maximum tolerable current density. Under high current conditions, this break-off phenomenon is known as self-cleaning.

As a result of the increasing miniaturisation, spacings between component connections have decreased to a few hundred micrometres, which is a distance that the tin whiskers can readily cross. As a result of the increasingly small current consumption of the electronic circuits, there is also no self-cleaning effect since the tin whiskers are no longer generally destroyed by the current flow in the event of short-circuits.

The occurrence of tin whiskers is particularly promoted by the action of mechanical stresses such as internal mechanical stresses in the tin layer or in the connections, which are then transmitted in turn to the tin layer by high temperatures and a high level of air humidity.

Therefore, a component failure as a result of tin whiskers occurs particularly often if a tin coating in the fitted state is exposed to a permanent mechanical pressure loading. This regularly occurs, for example, in the case of press-in contacts, film conductor contacts and injection-moulded tin surfaces.

A conventional method of reducing the formation of tin whiskers involves the addition of lead to the tin metal-coating. However, as a result of the introduction of the ROHS Guideline (Guideline 2011/65/EU of the European Parliament and the Council of 8 Jun. 2011 for limiting the use of specific dangerous substances in electrical and electronic devices, Official Journal EU (2011) No. L174, pages 88-110), such a low-whisker tin/lead alloy is now only permitted in exceptional cases, and is completely prohibited for applications in the plug type connector sector. Although other tin alloys, such as silver/tin, and the use of various tempering steps, have been found to inhibit the growth of whiskers, they fail to prevent whisker formation completely, so a residual risk of short-circuiting always is present.

In many industries involving human safety devices, particularly in the automotive sector, the residual risk of whisker formation is unacceptable, and electrical connectors must comply with high levels of reliability requirements.

Another conventional approach is to use a contact layer comprising nickel. However, it has been found that conventional nickel coatings require excessively high insertion forces when a press-in contact is pressed in to a printed circuit board. Such an excessively high insertion form often results in the deformation of the press-in contact itself or results in the printed circuit board hole becoming excessively damaged.

Therefore, electrical contact elements that have substantially reduced tin whisker formation, while having a sufficiently large retention forces and low press-in forces, would meet the required high levels of reliability.

### SUMMARY

In order to address the above or other problems, embodiments of the invention provide a method for producing an electrical contact element comprising the steps of providing a base material, and applying at least one electrically conductive contact layer to the base material. The contact layer has an outer surface which is elevated by roughness and which is suitable for receiving a lubricant.

### BRIEF DESCRIPTION OF THE DRAWINGS

The invention will now be described by way of example, with reference to the accompanying Figures, of which:

FIG. 1 is a cross-sectional view of a contact layer positioned on a base material;

FIG. 2 is a cross-sectional view of the contact layer positioned on an intermediate layer, which is positioned on the base material;

FIG. 3 is an electron scanning microscope image of a contact layer surface before being coated with a lubricant;

FIG. 4 is a plan view of a press-in contact before being pressed into a printed circuit board; and

FIG. 5 is a plan view of the press-in contact in an assembled state.

### DETAILED DESCRIPTION OF THE PREFERRED EMBODIMENTS

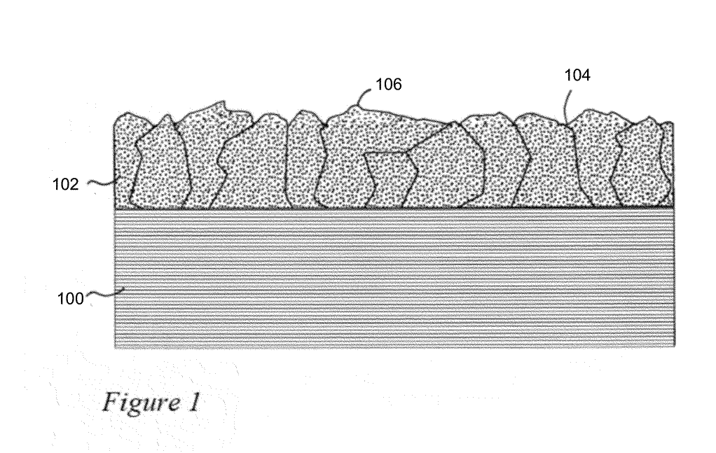

The invention will be explained in greater detail below with reference to FIGS. 1-5.

The starting point for the method is a base material 100. The base material 100 may be either a strip conductor or a plug pin or the like, and may be made of copper or a copper alloy, such as tin bronze, brass, high-strength brass or a CuNi, CuMn, CuNiSi, CuAl alloy.

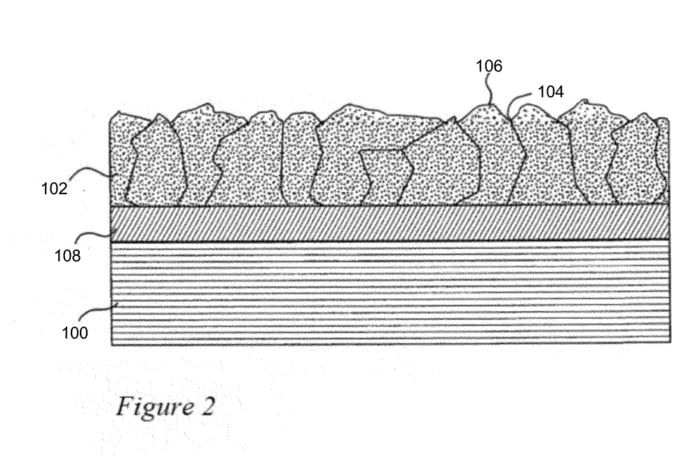

In the embodiments shown in FIGS. 1 and 2, only the region which is important for the electrical contacting is shown, that is to say, for example, the region of a press-in plug pin which is in contact with a contact hole. A tin-free metal coating which forms a contact layer 102 is applied to the base material 100 in this region.

A surface of the contact layer 102 is textured, having defined indentations 104 and elevations 106. The textured surface allows a lubricant (not illustrated in the Figures) to be retained on the surface of the contact layer 102 so as to be able to be stored for a long time. The elevations 106 may have extremely different shapes depending on how they are produced. They may be constructed, for example, to be pyramid-like, conical, spherical, clod-like, or columnar. In an embodiment, a height difference between the indentation 104 and the elevation 106 is generally between 0.4 μm and 10 μm. In an embodiment, the height different between the indentations 104 and the elevations 106 may be between 0.8 μm and 5 μm. If a lubricant having a viscosity between 1.5 mm²/s and 680 mm²/s is used in conjunction with the textured surface of the contact layer 102, an application of oil is capable of being stored for a long period of time without negatively influencing subsequent pressing-in operations. The lubricant may comprise, for example, a highly viscous oil. For application, the lubricant is mixed with a highly flowable solvent which acts as a carrier substance and which at least partially volatilises after application.

A significant aspect for preventing tin whiskers is that, in the region of the actual contacting (shown in FIGS. 1 and 2), there is no tin coating at the direct surface. To this end, the contact layer 102 is formed, for example, from iron, cobalt, nickel, rhodium, iridium, palladium, silver or an alloy comprising such elements.

In an embodiment, the tin-free contact layer 102 is deposited by means of electroplating technology. The parameters of the electroplating deposition, such as a composition of the bath, the addition of catalysts or acids, and current strengths and voltage values, may be adjusted in such a manner that the desired surface roughness is produced.

Those of ordinary skill in the art would appreciate that there may also be other deposition techniques which allow sufficient surface roughness with good adhesion, for the formation of the tin-free contact layer 102.

In an embodiment, a smooth metal coating layer may firstly be deposited, and then be roughened accordingly in a second process step, such as through an etching step. The roughened metal coating layer forms the tin-free contact layer 102 and the roughness is high enough to bond a lubricant therein in a durable manner.

In an embodiment shown in FIG. 2, the tin-free contact layer 102 is not applied directly to the base material 100 but instead is applied to an intermediate layer 108 positioned on the base material 100. The intermediate layer particularly facilitates the deposition of the contact layer 102 and improves the adhesion to the base material 100. In an embodiment, a smooth intermediate nickel layer 108 may be used for a nickel contact layer 102. In other embodiments, other metals and alloys may also be used as an intermediate layer 108.

It should be noted that the thickness relationships of FIG. 2 are not intended to be interpreted to be true to scale in any manner. In an embodiment, an intermediate layer 108 made of nickel has a thickness of 1 to 2 μm to the base layer 100, and the subsequently applied contact layer 102 is then formed from nickel having a thickness of 0.5 μm.

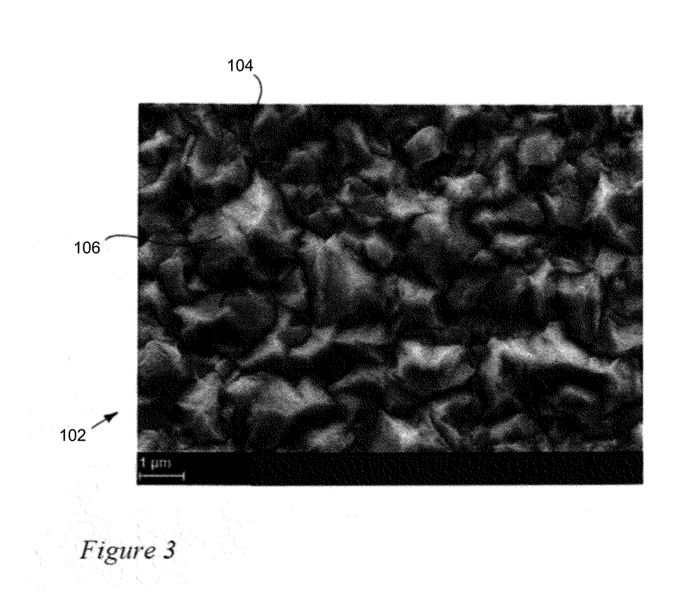

FIG. 3 is an electron scanning microscope image of a nickel contact layer 102 with the corresponding elevations 106 and indentations 106.

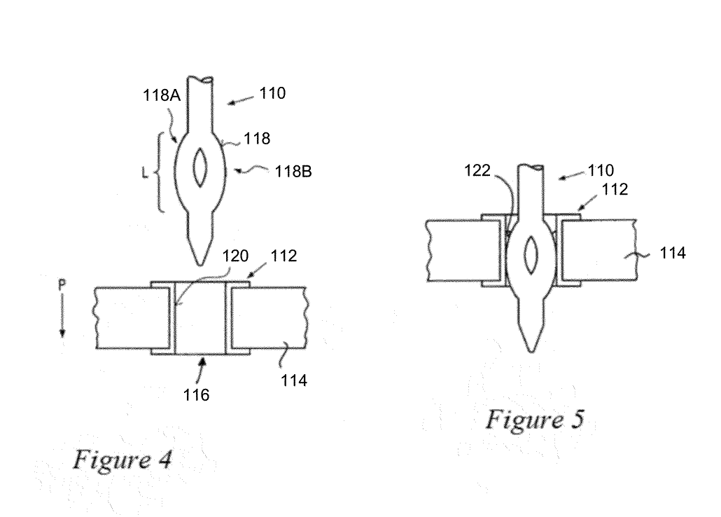

In an embodiment shown in FIG. 4, a press-in contact pin 110 is shown prior to insertion into a contact pin receiving hole disposed on a printed circuit board 114. In particular, the printed circuit board 114 has a socked receiving opening 116, in which an electrically conductive socket 112 is fitted. The press-in pin 110 has a surface portion 118 that is curved in a convex manner in the pressing-in direction (arrow P), being curved over a predetermined longitudinal length L. The curved surface portion 118 is formed on mutually opposing contacting members 118A, 118B which are formed on the press-in pin 110 in the region of the longitudinal length L, curve outwards from cylindrical longitudinal portions of the press-in pin and enclose a central empty space.

In the embodiment shown, the socket 112 is formed from substantially pure copper. The press-in pin 110 is also formed from copper, and, in the region of the curved surface portion 118, the contact layer 102 has a coating of oil prior to an assembly of the press-in pin to the socket 112.

In order to produce the press-in connection, the press-in pin 110 is moved relative to the printed circuit board 114 and the socket 112 in a mating direction (arrow P). The press-in pin 110 is firstly centered in the socket 112 with the mating end tip (not labelled), whose outer diameter is smaller than the inner diameter of the socket. With continuing movement in the mating direction P, the curved longitudinal portion 118 is finally introduced into the socket 112. In this instance, first the spacing between the outer peripheral surface of the press-in pin 110 and the inner peripheral face 120 of the socket 112 is reduced until both surfaces move into contact with each other. With continuing movement in the mating direction, the contacting members 118A, 118B are first resiliently deformed in a radially inward direction and finally, with further continuing movement, the material of the outer layer is plastically deformed.

In this state, the oil application retained at the surface of the contact layer 102 becomes effective as a lubricant so that a necessary insertion force remains sufficiently low during further movement in the mating direction P. With continuing movement in the mating direction P, material from the contact layer 102 is sheared off from the outer peripheral surface of the press-in pin 110, and a metallic plug 122 is formed between the rear flank of the curvature 118 in the mating direction P and the inner peripheral face 120 of the socket 112. The press type connection produced in this manner is, on the one hand, retained by resilient restoring forces of the contacting members 118A, 118B which are biased radially outwards and, on the other hand, by a possible cold welding between the surface material of the press-in pin 110 and the socket 112. The lubricant is also displaced outwards in this operation so that a reliable electrical contacting is ensured.

If no tin is involved in the region of the electrical contacting between the surface portion 118 and the socket 112, which is mechanically loaded by the pressing action, that is to say, the printed circuit board 114 also, does not contain any tin, the occurrence of tin whiskers can be prevented with complete certainty. If the printed circuit board 114 does contain tin, the growth of whiskers is substantially prevented by using press-in pins 110 with the contact layer 102.

The contact layer 102 may also advantageously be used with a large number of other electrical connections. For example, contact springs in plug type micro-connectors may be provided with the contact layer 102. Furthermore, the contact layer 102 is suitable for use for injection-moulded contact elements, solder connections, or film conductor contacts.

As a result of the complete omission of tin in the contact region, a technology which does not have any tin whisker growth has been shown. Therefore, the shearing of tin whiskers can also be prevented, as can short circuit bridging between adjacent electrically conductive structures.

What is claimed is:

1. A method for producing an electrical contact element, comprising the steps of:
providing a base material; and
applying at least one electrically conductive contact layer to the base material, the contact layer having an outer surface which is elevated by roughness and which is suitable for receiving a lubricant.

2. The method according to claim 1, further comprising the step of coating the outer surface of the contact layer with a lubricant.

3. The method according to claim 2, wherein the lubricant is an oil having a kinematic viscosity value between 1.5 mm²/s and 680 mm²/s.

4. The method according to claim 1, wherein the base material is produced from copper, tin bronze, brass, high-strength brass, a CuNi, CuMn, CuNiSi, or CuAl alloy or a weakly alloyed copper alloy.

5. The method according to claim 1, wherein the contact layer is a tin-free metal coating.

6. The method according to claim 5, wherein the tin-free metal coating is iron, cobalt, nickel, rhodium, iridium, palladium, silver or an alloy having any combination thereof.

7. The method according claim 1, wherein the contact layer has pyramid-like, conical, spherical, clod-like elevations, or a combination thereof.

8. The method according to claim 1, wherein the contact layer is electroplated on the base material, and a level of roughness is controlled by varying electroplating parameters.

9. The method according to claim 7, wherein a height of the elevations of the contact layer are approximately 0.4 μm and 10 μm.

10. The method according to claim 7, wherein a height of the elevations of the contact layer are approximately 0.8 μm and 5 μm.

11. The method according to claim 1, wherein at least one intermediate layer is positioned between the base material and the contact layer.

12. The method according to claim 11, wherein the intermediate layer is a nickel layer having surface roughness that is less than the surface roughness of the contact layer.

13. An electrical contact element having:
an electrically conductive base material having an outer surface; and
a contact layer positioned on the outer surface of the base material, and having an outer surface elevated by roughness.

14. The electrical contact element according to claim 13, further comprising a lubricant layer disposed on the outer surface of the contact layer, the lubricant layer being an oil with a kinematic viscosity value of approximately 1.5 mm²/s and 680 mm²/s.

15. The electrical contact element according to claim 13, wherein the electrical contact element is a press-in contact element, plug type contact element, injection-moulded contact element, solder connection contact element, or film conductor contact element.

16. The electrical contact element according claim 13, wherein the base material is copper, tin bronze, brass, high-strength brass, a CuNi, CuMn, CuNiSi or CuAl alloy, or a weakly alloyed copper alloy.

17. The electrical contact element according to claim 13, wherein the contact layer is a tin-free metal coating.

18. The electrical contact element according to claim 17, wherein the tin-free metal coating is iron, cobalt, nickel, rhodium, iridium, palladium, silver or an alloy comprising a combination thereof.

19. The electrical contact element according to claim 13, wherein the contact layer has pyramid-like, conical, spherical, or clod-like elevations, or a combination thereof.

20. The electrical contact element according to claim 19, wherein a height of the elevations is approximately 0.4 μm and 10 μm.

21. The electrical contact element according to claim 19, wherein a height of the elevations is approximately 0.8 μm and 5 μm.

22. The electrical contact element according to claim 13, further comprising at least one intermediate layer positioned between the base material and the contact layer.

23. The electrical contact element according to claim 22, wherein the intermediate layer is a nickel layer having a surface roughness that is less than the surface roughness of the contact layer.
